(19) United States
(12) Patent Application Publication
(10) Pub. No.: US 2024/0308114 A1
(43) Pub. Date: Sep. 19, 2024

(54) FLOOR WITH SPECIALLY-TREATED EDGE AND MANUFACTURING PROCESS THEREOF

(71) Applicant: Huizhou Weikang New Building Materials Co., Ltd, Huizhou (CN)

(72) Inventors: Ping Hong Leung, Huizhou (CN); Li Yuanyang, Huizhou (CN); Zhou Qiang, Huizhou (CN); Gan ZuGuo, Huizhou (CN)

(73) Assignee: Huizhou Weikang New Building Materials Co., Ltd, Huizhou (CN)

(21) Appl. No.: 18/184,642

(22) Filed: Mar. 15, 2023

(51) Int. Cl. B29C 33/42; B29C 33/02; B29C 33/22

(52) U.S. Cl. CPC B29C 33/424; B29C 33/02; B29C 33/22; B29C 2793/0027; B29L 2031/732

(57) ABSTRACT

The present invention relates to the technical field of floors, in particular to a floor with a specially-treated edge and a manufacturing process thereof, wherein clamping grooves are provided around a floor body, the transition between the clamping groove and the floor surface is constructed as an are or an irregular concave-convex surface, and a three-stage molding process is used: pressing and locating, die cutting into blocks, and maintaining pressure for shaping; after being processed, the floor has been cut into small pieces as a whole, and there are clamping grooves with a fixed size around the floor body; a joint between each piece of the floor is constructed as an arc or an irregular concave-convex surface; the floor with a specially-treated edge processed in this way solves the problem of inaccurate location caused by the sawing processing, and the present invention can realize mass production.

### TECHNICAL FIELD

The present invention relates to the technical field of flooring, in particular to an

elastic floor with a specially-treated edge and a manufacturing process thereof.

### BACKGROUND

At present. the common elastic floors in the market have edges that are mostly right-angled, non-processed or commonly processed with bevels, which is easy to cause aesthetic fatigue. There are also some special floors with specially-treated edges which hard to find but popular. However, due to the tedious manufacturing process, low yield and low unit price, few manufacturers are willing to produce such kind of floors.

At present, there are mainly two methods for manufacturing the elastic floor with a specially-treated edge in the market:

method 1: a cutting process for processing an are shape on an edge of a floor can be performed: a small semi-finished floor, after being processed by a grooving machine or a chamfering machine, is cut out an are with the rapid rotation of a cutter; in this way, the processing efficiency is high, but the tooth marks on the are cannot be eliminated, and the gloss of the arc surface is obviously different from that of the uncut part, so it needs secondary treatment, and the processing process is complicated and easy to produce bad results.

Method 2: in a molding or rolling process, an edge of a floor can be constructed with an arc or an inclined face; an embossing plate or embossing roller constructed with an arc or an inclined face is selected for use with other materials to prepare a whole semi-finished product at high temperature and under high pressure. and then same is prepared to get a finished product by processes such as coating, sawing and clamping grooves. The floor with a specially-treated edge manufactured by this process has the problem of air bubbles or stretching which cannot be completely overcome. At the same time, the color of the location where an edge of the floor is specially-treated is easy to be different from that of other locations. When coating, the bottom of the floor with a specially-treated edge cannot be coated, which is easy to cause the difference in gloss, and the biggest problem is that it cannot be accurately located and cut when being sawed, resulting in an inaesthetic edge of a final finished floor.

Therefore, in view of the above problems, the present invention provides a floor with a specially-treated edge.

### SUMMARY

It is an object of the present invention to provide a floor with a specially-treated edge and a manufacturing process thereof to solve the problems set forth in the above background art.

In order to achieve the above object, the present invention provides the following scheme:
as an alternative to the floor with a specially-treated edge and the manufacturing process thereof according to the present invention, wherein the floor with a specially-treated edge and a die apparatus required for manufacturing same comprising an upper die and a lower die, wherein an upper locating post provided vertically is fixedly connected to either side of the bottom of the upper die, upper die cores uniformly distributed are fixedly connected to the bottom of the upper die, a cutter is provided between the upper die cores. the top of the cutter is fixedly connected to the upper die. a spring is fixedly connected below the upper die core, and a connecting pressing plate is fixedly connected to the bottom of the spring for ejecting a formed semi-finished product to avoid being caught at the die core, and a lower locating post is fixedly connected to four corners above the lower die; the lower locating post and the upper locating post are used for locating when the upper and lower dies are opened and closed, and lower die cores are fixedly connected to four corners above the lower die, and the upper die cores and the lower die cores are fixed on both the upper die and the lower die for ensuring the size of the product after die cutting.

As an alternative to the floor with a specially-treated edge and the manufacturing process thereof according to the present invention, wherein an edge-shaping die is provided between the die core and the cutter on the mold, a heating device is mounted inside the edge-shaping die, and the cutter is used for cutting off the semi-finished product; the purpose of the heating device is to facilitate an effect of the edge of the floor and better shaping of the clamping groove, while ensuring a suitable temperature.

As an alternative to the floor with a specially-treated edge and the manufacturing process thereof according to the present invention, wherein a groove-clamping position is reserved for the edge-shaping die.

As an alternative to the floor with a specially-treated edge and the manufacturing process thereof according to the present invention, wherein a lower elastic pressing strip is provided on the outer side of the lower die core, the bottom of the lower elastic pressing strip is fixedly connected to the lower die, an upper elastic pressing strip is mounted at the edge of the cutter, the top of the upper elastic pressing strip is fixedly connected to the upper die, and the upper and lower elastic pressing strips are provided for fixing the semi-finished product to prevent deformation that easily occurs under pressure.

As an alternative to the floor with a specially-treated edge and the manufacturing process thereof according to the present invention, the manufacturing steps are as follows:
step 1: in operation, mounting an upper die of a mold above a press, and mounting a lower die on a table of the press, and controlling opening and closing of the die by lifting of the press:
step 2: placing the whole semi-finished product in the middle between the upper and lower dies of the mold, turning on a die heating switch in advance, so that a heating device heats up in advance, a press descends after being turned on, and an upper die spring; pressing the floor by a pressing plate and an elastic pressing strip, then continuing to descend the press, cutting the floor into small pieces of a fixed size under the action of the pressure of the press, then continuing to press down the press to make an edge of the floor in full contact with an edge-shaping die in the mold, keeping the pressure for 5-60 S according to different environments and different materials. and the edge-shaping die pressing a shape of the edge-shaping die and a pattern of the groove-clamping position around the floor under the action of pressure and heat, after the pressure-maintaining duration is over, the press is lifted, and the upper and lower dies are separated; the semi-finished product in the die core is ejected by an inner spring and a pressing plate of the die to achieve an effect that an edge-shaping die and a groove-clamping position are provided around the small piece of a semi-finished product; and
step 3: placing a small piece of a semi-finished product constructed with an edge-shaping die and a groove-clamping position in a grooving machine at a fixed position, and processing a clamping groove at the groove-clamping position; wherein the clamping groove processing is a common technique in the floor industry, and is not described in any more detail herein. Then the floor with a specially-treated edge is processed, and there might be an optional processing, such as adding a sound-absorbing pad or the like to the back of the floor.

Compared with the prior art, the present invention has the following beneficial effects:
according to the present invention, for the floor with a specially-treated edge processed by this method, a traditional die cutting method is used in the molding section, and the size of the produced products is uniform and more accurate than that of the product produced by the sawing method, thus solving the problem that the location and size of the clamping groove are different due to the sawing method, and the clamping groove processing cannot ensure the integrity of the edge of the floor; an edge-shaping die and a heating device are added inside the die cutting mold, in combination with a high-power press and a pressure-maintaining program, the shape of the edge-shaping die and the unification of the glossiness and size of the semi-finished floor product are ensured, and the problems of irregular edges pressed, easy discoloration and gloss difference of traditional embossing template or embossing roller are solved, and the clamping groove only needs to be processed at the reserved groove-clamping position, which will not affect other locations of the edge-shaping dic.

### BRIEF DESCRIPTION OF DRAWINGS

FIG. 1 is a simplified sectional view showing a full arc effect of the floor with a specially-treated edge according to the present invention.

FIG. 2 is a simplified sectional view showing another smooth are effect of the floor with a specially-treated edge according to the present invention;

FIG. 3 is a simplified sectional view showing an effect of irregular concavo-convex surface of the floor with a specially-treated edge according to the present invention;

FIG. 4 is a schematic view showing the overall structure of the mold of the present invention;

FIG. 5 is a schematic view showing one of the arc-shaped dies according to the enlarged structure of FIG. 4A.

In the figure: 1, upper die; 2, upper locating post; 3, upper pressing strip; 4, upper mold core: 5, cutter; 6, spring: 7, pressing plate; 8, edge-shaping die; 9, heating device; 11, lower die; 12, lower locating post; 13, lower pressing strip; 14, lower mold core.

### DETAILED DESCRIPTION OF THE EMBODIMENTS

The present invention will be described in detail with reference to the accompanying drawings for a more complete understanding.

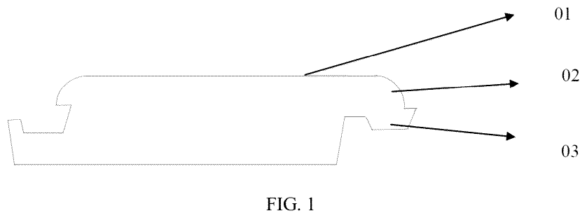

The present invention provides a floor with a specially-treated edge, as shown in FIG. 1, with a smooth and full are angle 02, the gloss of the are angle 02 is consistent with the gloss of the floor surface 01, and a clamping groove 03 is provided around the arc angle 02 for quick assembly.

With reference to FIGS. 1-5, the present invention provides a technical solution: a floor with a specially-treated edge and a manufacturing process thereof, the
apparatus comprises an upper die 1 and a lower die 11, wherein an upper locating post 2 provided vertically is fixedly connected to either side of the bottom of the upper die 1, upper die cores 4 uniformly distributed are fixedly connected to the bottom of the upper die 1. a cutter 5 is provided between the upper die cores 4, the top of the cutter 5 is fixedly connected to the upper die 1, a spring 6 is fixedly connected below the upper die cores 4, and a connecting pressing plate 7 is fixedly connected to the bottom of the spring 6 for ejecting a formed semi-finished product to avoid being caught at the die core, and a lower locating post 12 is fixedly connected to four corners above the lower die 11; the lower locating post 12 and the upper locating post 2 are used for locating when the upper and lower die 11 are opened and closed, and lower die cores 14 are fixedly connected to four corners above the lower die 11, and the upper die cores 4 and the lower die cores 14 are fixed on both the upper die I and the lower die 11 for ensuring the size of the product after die cutting.

An edge-shaping die 8 is provided between the upper mold core 4 and the cutter 5, and a heating device 9 is mounted inside the edge-shaping die 8.

The cutter 5 is used for cutting the semi-finished product, and the arrangement of the heating device 9 ensures that under the effect of temperature, the molding of the floor edge-shaping die and the groove-clamping position are facilitated.

The bottom of the above-mentioned edge-shaping die 8 is provided with a groove-clamping position, and the edge-shaping die 8 and the groove-clamping position are integrally provided.

A lower elastic pressing strip 13 is provided on the outer side of the lower die core 14, the bottom of the lower elastic pressing strip 13 is fixedly connected to the lower die 11, an upper elastic pressing strip 3 is mounted at the edge of the cutter 5. the top of the upper elastic pressing strip 3 is fixedly connected to the upper die 1, and the upper elastic strip 3 is provided for fixing the semi-finished product to prevent deformation that easily occurs under pressure.

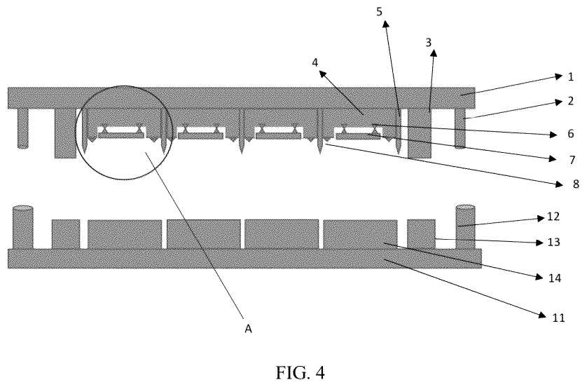

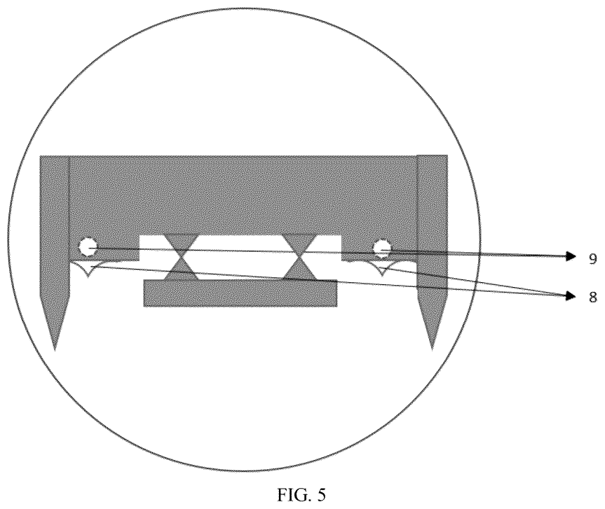

A three-stage molding process is adopted by using a die with a heating function for forming an arc angle in an edge-shaping die (FIGS. 4 and 5) in combination with a high-power press: a three-stage molding process is used: pressing and locating, die cutting into blocks, and maintaining pressure for shaping;
stage 1: pressing and locating, a floor is paced in a die with an arc angle shaped edge-shaping die, pressed down by a press, the floor is fixed by means of a spring 6, a pressing plate 7 and a surrounding elastic pressing strip in the die core, to prevent a large area of irregular deformation after the floor is subjected to a force, and guarantee the straight angle of the product;
stage 2: die cutting into blocks: after the floor is located, the press continues to press down, the cutter S in the upper die descends, and the floor is cut into blocks;
stage 3: maintaining pressure for shaping: after the floor is cut into small pieces, the press continues to press down while maintaining the pressure, and the edges of the small pieces of the floor are pressed out of the groove-clamping position under the action of heat and pressure, and an arc effect is achieved by pressing at a transition between the groove-clamping position of the floor and an effective area of the floor, and the arc construction is controlled by the temperature of the mold, the pressure of the press and the pressure-maintaining time.

### Embodiment 1:

The manufacturing steps are as follows:
step 1: as shown in FIG. 4, an upper die of a mold is mounted above a press in operation, and a lower die is mounted on a table of the press, and opening and closing of the die is controlled by lifting of the press;
step 2: as shown in FIG. 4 , the whole semi-finished product is placed in the middle of the upper and lower dies of the die, the heating switch of the die is turned on in advance, so that the heating device 9 heats in advance, the temperature is set as 90° C., the press descends after being turned on, a section of pressure is set as 100 kg, and the upper die spring 6, the pressing plate 7 and the elastic pressing strip 3 press the floor: then the press continues descends, the pressure in the second stage is set to 200 kg, and the cutter 5 cuts the floor into small pieces of a fixed size under the action of the press pressure: then, the press continues to press down, and the three-stage pressure is set to 300 kg, so that the edge of the floor is in full contact with the edge-shaping die 8 in the mold, and the pressure is maintained for 40 S, and under the action of pressure and heat, the edge-shaping die 8 presses the four sides of the floor with pattern of the edge-shaping die and the groove-clamping position. After the pressure-maintaining time is reached, the press is lifted, the upper and lower dies are separated, and the semi-finished product in the die core 4 is ejected by the inner spring 6 and the pressing plate 7 of the die to achieve the effect that the semi-finished product has a full are and a groove-clamping position around the four sides;
step 3: a small piece of a semi-finished product with an are angle 02 and a groove-clamping position is placed in a grooving machine at a fixed position, and a clamping groove 03 is machined at the groove-clamping position; this clamping groove processing is a common technique in the floor industry, and will not be described in any more detail herein, thus the processing of an edge specially-treated as a full are can be achieved, and it is also possible to add a sound-absorbing pad or the like on the back of the floor.

### Embodiment 2:

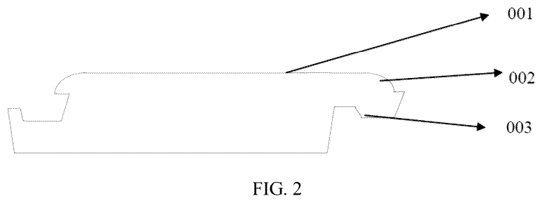

The present invention provides a floor with a specially-treated edge with a smooth transition at are angle 002 as shown in FIG. 2, the gloss of the are angle 002 is consistent with the gloss of the floor surface 001, and the arc angle 002 is provided with a clamping groove 003 around for quick assembly.

With reference to FIGS. 1-5, the present invention provides another technical solution:
the manufacturing steps are as follows:
step 1: as shown in FIG. 4, an upper die of a mold is mounted above a press in operation, and a lower die is mounted on a table of the press, and opening and closing of the die is controlled by lifting of the press;
step 2: as shown in FIG. 4 , the whole semi-finished product is placed in the middle of the upper and lower dies of the die, the heating switch of the die is turned on in advance, so that the heating device 9 heats in advance, the temperature is set as 90° C., the press descends after being turned on, a section of pressure is set as 100 kg, and the upper die spring 6, the pressing plate 7 and the elastic pressing strip 3 press the floor; then the press continues descends, the pressure in the second stage is set to 200 kg. and the cutter 5 cuts the floor into small pieces of a fixed size under the action of the press pressure: then, the press continues to press down, and the three-stage pressure is set to 300 kg, so that the edge of the floor is in full contact with the edge-shaping die 8 in the mold, and the pressure is maintained for 25 S, and under the action of pressure and heat, the edge-shaping die 8 presses the four sides of the floor with pattern of the edge-shaping die and the groove-clamping position. After the pressure-maintaining time is reached, the press is lifted, the upper and lower dies are separated, and the semi-finished product in the die core 4 is ejected by the inner spring 6 and the pressing plate 7 of the die to achieve the effect that the semi-finished product has a smooth arc and a groove-clamping position around the four sides;
step 3: a small piece of a semi-finished product with an arc angle 002 and a groove-clamping position is placed in a grooving machine at a fixed position, and a clamping groove 003 is machined at the groove-clamping position; this clamping groove processing is a common technique in the floor industry, and will not be described in any more detail herein, thus the processing of an edge specially-treated as a smooth arc can be achieved, and it is also possible to add a sound-absorbing pad or the like on the back of the floor.

### Embodiment 3:

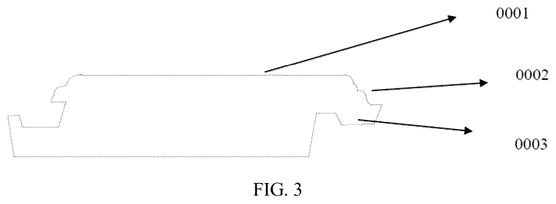

The present invention provides a floor with a specially-treated edge, as shown in FIG. 3, wherein the edge of the floor is constructed as an irregular concave-convex surface to achieve an effect of a high imitation of wear, the irregular concave-convex surface 0002 has a gloss like that of the floor surface 0001, and a clamping groove 0003 is provided around the arc angle 0002 for quick assembly.

Referring to FIGS. 1-5, the present invention provides another edge treatment effect:
the manufacturing steps are as follows:
step 1: as shown in FIG. 4, an upper die of a mold is mounted above a press in operation, and a lower die is mounted on a table of the press, and opening and closing of the die is controlled by lifting of the press; (use a mold having an internal sizing die which is constructed as an irregular concave and convex surface)
step 2: as shown in FIG. 4 , the whole semi-finished product is placed in the middle of the upper and lower dies of the die, the heating switch of the die is turned on in advance, so that the heating device 9 heats in advance, the temperature is set as 90° C., the press descends after being turned on, a section of pressure is set as 100 kg, and the upper die spring 6, the pressing plate 7 and the elastic pressing strip 3 press the floor; then the press continues descends, the pressure in the second stage is set to 200 kg, and the cutter 5 cuts the floor into small pieces of a fixed size under the action of the press pressure; then, the press continues to press down, and the three-stage pressure is set to 330 kg, so that the edge of the floor is in full contact with the edge-shaping die 8 in the mold, and the pressure is maintained for 55 S, and under the action of pressure and heat, the edge-shaping die 8 presses the four sides of the floor with pattern of the edge-shaping die and the groove-clamping position. After the pressure-maintaining time is reached, the press is lifted, the upper and lower dies are separated, and the semi-finished product in the die core 4 is ejected by the inner spring 6 and the pressing plate 7 of the die to achieve the effect that the semi-finished product has an irregular concave-convex surface and a groove-clamping position around the four sides;
step 3: a small piece of a semi-finished product with an irregular concave-convex surface 0002 and a groove-clamping position is p in a grooving machine at a fixed location, and a clamping groove 0003 is machined at the groove-clamping position; this clamping groove processing is a common technique in the floor industry, and is not described in any more detail herein, and thus an edge of a floor is specially-treated to be an irregular concave-convex surface, and a sound-absorbing pad or the like can also be selectively added to the back of the floor.

The pressure-maintaining time of embodiment 1 is different from that of embodiment 2, which is reflected in the degree of arc fullness, and the pressure-maintaining time is long, as shown in FIG. 1. the arc is full; the pressure-maintaining time is short and the arc is smooth as shown in FIG. 2.

The molds used in Examples 1 and 3 are different and have different effects on an edge of a floor. A die having an edge-shaping die constructed as an arc angle is used for processing a product as shown in FIGS. 1 and 2, and a die having an edge-shaping die constructed as an irregular concave-convex surface is used for processing a product as shown in FIG. 3. Since the die constructed as an arc angle has a similar structure to that of the die constructed as an irregular concave-convex surface, and only the inner edge-shaping die of the mold is different, FIG. 4 is combined in use for description of the above.

The principles and embodiments of the present invention have been described with specific examples, which are presented to aid in the understanding of the methods and core concepts of the present invention. The above-mentioned description is merely a preferred embodiment of the present invention, and it should be pointed out that due to the limited nature of the wording, there is objectively an unlimited specific structure; for a person of ordinary skill in the art, several improvements, modifications and changes can also be made without departing from the principle of the present invention, and the above-mentioned technical features can also be combined in an appropriate manner; such modifications, variations or combinations, or applications of the inventive concepts and solutions directly to other applications without modification are intended to be within the scope of the present invention.

What is claimed is:

1. An apparatus for manufacturing a floor with a specially-treated edge, comprising an upper die (1) and a lower die (11), wherein an upper locating post (2) provided vertically is fixedly connected to either side of the bottom of the upper die (1), upper die cores (4) uniformly distributed are fixedly connected to the bottom of the upper die (1), a cutter (5) is provided between the upper die cores (4), the top of the cutter (5) is fixedly connected to the upper die (1), a spring (6) is fixedly connected below the upper die cores (4), and a pressing plate (7) is fixedly connected to the bottom of the spring (6), a lower locating post (12) is fixedly connected to four corners above the lower die (11), and lower die cores (14) are fixedly connected to four corners above the lower die (II).

2. The apparatus for manufacturing a floor with a specially-treated edge according to claim 1, wherein an edge-shaping die (8) is provided between the upper die cores (4) and the cutter (5), and a heating device (9) is mounted inside the edge-shaping die (8).

3. The apparatus for manufacturing a floor with a specially-treated edge according to claim 1, wherein a groove-clamping position is reserved for the edge-shaping die (8).

4. The apparatus for manufacturing a floor with a specially-treated edge according to claim 1, wherein a lower elastic pressing strip (13) is provided on an outer side of the lower die core (14), the bottom of the lower elastic pressing strip (13) is fixedly connected to the lower die (11), an upper elastic pressing strip (3) is mounted at an edge of the cutter (5), and the top of the upper elastic pressing strip (3) is fixedly connected to the upper die (1).

5. The apparatus for manufacturing a floor with a specially-treated edge according to claim 1, wherein
the manufacturing steps are as follows:
step 1: in operation, mounting an upper die of a mold above a press, and mounting a lower die on a table of the press, and controlling opening and closing of the die by lifting of the press;
step 2: placing the whole semi-finished product in the middle between the upper and lower dies of the mold, turning on a die heating switch in advance, so that a heating device (9) heats up in advance, a press descends after being turned on; pressing the floor by an upper die spring (6), a pressing plate (7) and an elastic pressing strip (3), then continuing to descend the press, cutting the floor into small pieces of a fixed size under the action of the pressure of the press, then continuing to press down the press to make an edge of the floor in full contact with an edge-shaping die (8) in the mold; keeping the pressure for 5-60 S according to different environments and different materials, and the edge-shaping die (8) pressing a shape of the edge-shaping die and a pattern of the groove-clamping position around the floor under the action of pressure and heat, after the pressure-maintaining duration is over, lifting the press. and separating the upper and lower dies; ejecting the semi-finished product in the die cores (4) by an inner spring (6) and a pressing plate (7) of the die to achieve an effect that an edge-shaping die and a groove-clamping position are provided around the small piece of a semi-finished product; and
step 3: placing a small piece of a semi-finished product constructed with an edge-shaping die and a groove-clamping position in a grooving machine at a fixed position, and processing a clamping groove at the groove-clamping position; wherein the clamping groove processing is a common technique in the floor industry, and is not described in any more detail herein, and thus the processing of the floor with a specially-treated edge is completed, and a sound-absorbing pad or the like can also be selectively added to the back of the floor.
